(19) United States
(12) Patent Application Publication
(10) Pub. No.: US 2026/0150081 A1
(43) Pub. Date: May 28, 2026

(54) METHODS FOR USING A DEEP LEARNING MODEL FOR UNIVERSAL USER DEVICE POSITIONING

(71) Applicant: InterDigital Patent Holdings, Inc., Wilmington, DE (US)

(72) Inventors: Shahab Hamidi-Rad, Sunnyvale, CA (US); Akshay Malhotra, San Jose, CA (US); Aditya Sant, Los Altos, CA (US); Keya Patani, London (GB); Rushabha Balaji, Los Angeles, CA (US)

(73) Assignee: InterDigital Patent Holdings, Inc., Wilmington, DE (US)

(21) Appl. No.: 18/957,095

(22) Filed: Nov. 22, 2024

(51) Int. Cl. H04W 64/00; H04B 17/318; H04W 24/02

(52) U.S. Cl. CPC H04W 64/003; H04B 17/328; H04W 24/02

(57) ABSTRACT

A method implemented by a wireless transmit/receive unit (WTRU) may include receiving TRP position information, including spatial coordinates, for a variable number of transmit/receive points (TRPs). Feature vectors may be generated by extracting features related to positioning from TRP channel information based on the signal and spatial information associated with each of the TRPs. Embeddings may be generated as latent representations in a high-dimensional embedding space based on the feature vectors and TRP position information. A contextual representation of spatial relationships may be generated based on the embeddings using a deep neural network (DNN) model, trained on data including varying TRP numbers and geometric configurations, enabling generalization across different environments. The DNN model may learn to infer a position of the WTRU during training based on the embeddings. A predicted position of the WTRU may be determined using the contextual representation based on inferred spatial relationships in the DNN model.

### BACKGROUND

In the past few years, accurate localization of WTRUs has become an important field of study in wireless communication, attracting a lot of attention. The emergence of new applications such as unmanned aerial vehicles (UAVs), multisensory extended reality (XR), internet of things (IoT), autonomous vehicles, and others has highlighted the need for high-precision positioning of both transmitter and receiver. Additionally for the next generation wireless communication standards to achieve the promised performance excellence in terms of throughput, latency, and reliability, in acceptable transmission distances, both the transmitter and the receiver require knowledge of each other's relative position and orientation.

Deep-learning models have been designed and trained to predict the position of a user device using different measured parameters such as time-difference of arrival (TDOA), channel impulse response (CIR), and reference signal received power (RSRP) to name a few. The idea is that these parameters capture the characteristics of the wireless propagation environment at a particular location within the environment and each location has a unique signature or “fingerprint”. By sampling the environment, a dataset of fingerprints can be built and used to train an AI/ML-model to learn the characteristics of the radio environment associated with each position. These models have shown significant improvement over traditional methods in both line-of-sight (LOS) and non-line-of-sight (NLOS) channel environments. The AI/ML based WTRU positioning has also been included as a study item in 3GPP standard.

Most of positioning use-cases currently being studied (including the ones being considered in 3GPP) involve a static environment and an AI/ML model that learns the fingerprints of each location and maps each fingerprint to the position coordinates. The problem with this approach is that the trained model can only operate in the original static environment. As a user moves to a different environment, there is a significant degradation in the accuracy of the model predictions. Another problem these models face is that they usually fail to generalize to the changes in the environment such as people or vehicles moving around. This is because the position fingerprints change causing the trained model to predict the wrong location.

### SUMMARY

A wireless transmit/receive unit (WTRU) may include a processor. The processor may be configured to receive TRP position information for each of a variable number of transmit/receive points (TRPs). The TRP position information may include spatial coordinates for each of the variable number of TRPs. Feature vectors may be generated by extracting features related to positioning from TRP channel information associated with each of the variable number of TRPs, with the TRP channel information including signal and spatial information. The feature extraction may be based on the signal and spatial information associated with each of the variable number of TRPs. Embeddings may be generated as latent representations in a high-dimensional embedding space based on the feature vectors and the TRP position information. A contextual representation of spatial relationships may be generated based on the embeddings using a trained deep neural network (DNN) model. The DNN model may be trained on training data including varying numbers and geometric configurations of TRPs to enable generalization across different environments. The DNN model may learn to infer a position of the WTRU during training based on the embeddings. A predicted position of the WTRU may be determined using the contextual representation of spatial relationships based on inferred spatial relationships in the DNN model.

The TRP channel information may include at least one of a channel matrix, channel impulse response (CIR), time difference of arrival (TDOA), or reference signal received power (RSRP) associated with the TRPs.

The embeddings may be generated by combining the feature vectors with the TRP position information of corresponding TRPs.

The contextual representation of spatial relationships may include inferred relationships between the variable number of TRPs and the WTRU based on the embeddings.

The DNN model may be agnostic to different numbers of TRPs and geometric configurations, and the predicted position of the WTRU may be determined using the contextual representation of spatial relationships based on inferred spatial relationships in the DNN model without retraining the DNN model.

The DNN model may include an output regression component configured to determine the predicted position of the WTRU by mapping the contextual representation of spatial relationship to coordinates within a common Cartesian coordinate system.

The DNN model may be configured to generate the contextual representation of spatial relationships and to determine the predicted position of the WTRU in both line-of-sight (LOS) and non-line-of-sight (NLOS) conditions.

The contextual representation of spatial relationships may include encoded positioning data based on learned relationships between the TRP position information and the TRP channel information.

The DNN model may include a class token added to the embeddings. The class token may provide an input sequence that makes the network invariant to a total number of TRPs.

The DNN model may include a transformer-based feature processing block configured to receive the embeddings and the class token, wherein the class token has an initial value learned during DNN training.

Methods implemented by a wireless transmit/receive unit (WTRU) may be described herein. The method may include receiving TRP position information for each of a variable number of transmit/receive points (TRPs). The TRP position information may include spatial coordinates for each of the variable number of TRPs. Feature vectors may be generated by extracting features related to positioning from TRP channel information associated with each of the variable number of TRPs, with the TRP channel information including signal and spatial information. The feature extraction may be based on the signal and spatial information associated with each of the variable number of TRPs. Embeddings may be generated as latent representations in a high-dimensional embedding space based on the feature vectors and the TRP position information. A contextual representation of spatial relationships may be generated based on the embeddings using a trained deep neural network (DNN) model. The DNN model may be trained on training data including varying numbers and geometric configurations of TRPs to enable generalization across different environments. The DNN model may learn to infer a position of the WTRU during training based on the embeddings. A predicted position of the WTRU may be determined using the contextual representation of spatial relationships based on inferred spatial relationships in the DNN model.

The TRP channel information may include at least one of a channel matrix, channel impulse response (CIR), time difference of arrival (TDOA), or reference signal received power (RSRP) associated with the TRPs.

The embeddings may be generated by combining the feature vectors with the TRP position information of corresponding TRPs.

The contextual representation of spatial relationships may include inferred relationships between the variable number of TRPs and the WTRU based on the embeddings.

The DNN model may be agnostic to different numbers of TRPs and geometric configurations, and the predicted position of the WTRU may be determined using the contextual representation of spatial relationships based on inferred spatial relationships in the DNN model without retraining the DNN model.

The DNN model may include an output regression component configured to determine the predicted position of the WTRU by mapping the contextual representation of spatial relationship to coordinates within a common Cartesian coordinate system.

The DNN model may be configured to generate the contextual representation of spatial relationships and to determine the predicted position of the WTRU in both line-of-sight (LOS) and non-line-of-sight (NLOS) conditions.

The contextual representation of spatial relationships may include encoded positioning data based on learned relationships between the TRP position information and the TRP channel information.

The DNN model may include a class token added to the embeddings. The class token may provide an input sequence that makes the network invariant to a total number of TRPs.

The DNN model may include a transformer-based feature processing block configured to receive the embeddings and the class token, wherein the class token has an initial value learned during DNN training.

### BRIEF DESCRIPTION OF THE DRAWINGS

FIG. 1A is a system diagram illustrating an example communications system in which one or more disclosed embodiments may be implemented.

FIG. 1B is a system diagram illustrating an example wireless transmit/receive unit (WTRU) that may be used within the communications system illustrated in FIG. 1A according to an embodiment.

FIG. 1C is a system diagram illustrating an example radio access network (RAN) and an example core network (CN) that may be used within the communications system illustrated in FIG. 1A according to an embodiment.

FIG. 1D is a system diagram illustrating a further example RAN and a further example CN that may be used within the communications system illustrated in FIG. 1A according to an embodiment.

FIG. 2A is a schematic illustration of an example system environment that may implement an AI/ML model.

FIG. 2B illustrates an example of a neural network.

FIG. 3 is a system diagram illustrating an example positioning of a WTRU relative to a plurality of transmit/receive points (TRPs).

FIG. 4 is a diagram illustrating a comparison of an example fingerprint-based Artificial Intelligence/Machine Learning (AI/ML) positioning model and an example universal positioning deep neural network (DNN) model.

FIG. 5 is a diagram illustrating an example structure of a dataset for supervised training of a DNN for environment-agnostic WTRU positioning.

FIG. 6 is a diagram illustrating an example organization of a dataset for supervised training of a DNN for environment-agnostic WTRU positioning.

FIG. 7 is a diagram illustrating an example 3-dimensional (3D) city environment for generating experimental results.

FIG. 8 is a diagram illustrating an example implementation for an environment-agnostic deep-learning model for WTRU positioning.

FIG. 9 Is a diagram illustrating example performance results of deep-learning models trained in different scenarios.

FIG. 10 is a diagram illustrating an example implementation of an environment agnostic position network.

FIGS. 11A and 11B show a diagram illustrating an example feature extraction from a channel's channel impulse response (CIR).

FIG. 12 is a diagram illustrating an example embedding block.

FIG. 13 is a block diagram illustrating an example transformer-based feature processing block utilizing generated embeddings.

FIG. 14 is a diagram illustrating an example output regression block.

FIG. 15 is a diagram illustrating an example method for determining WTRU positioning using an environment-agnostic deep-learning model.

### DETAILED DESCRIPTION

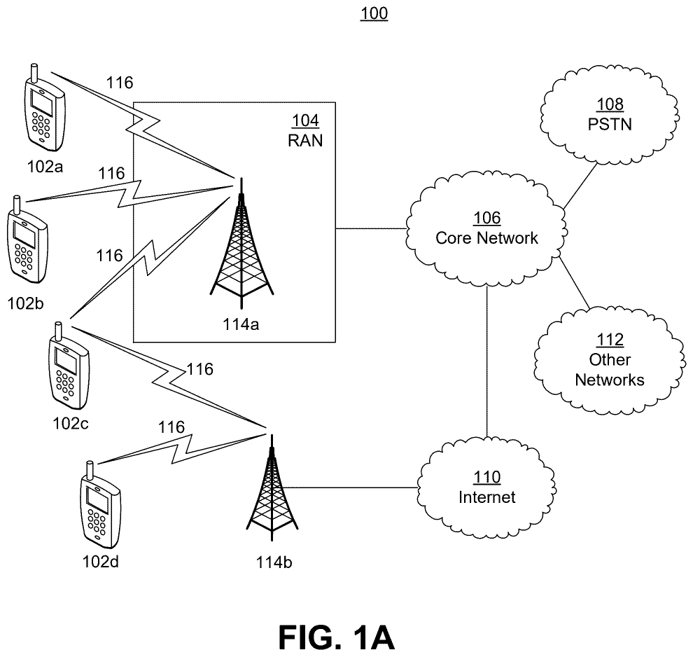

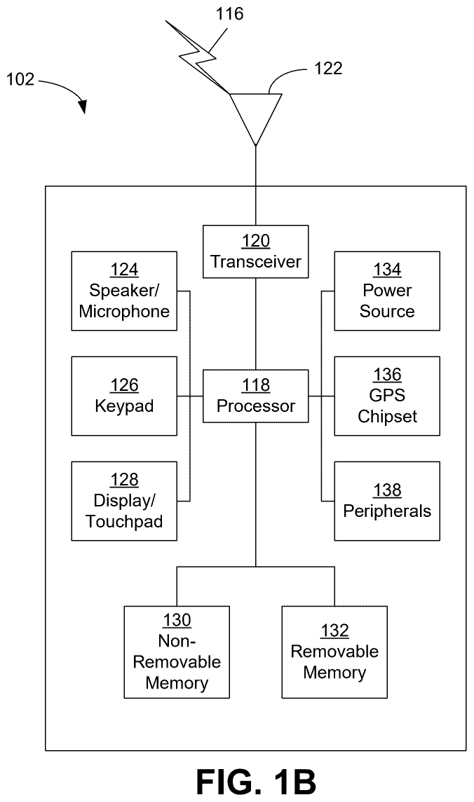

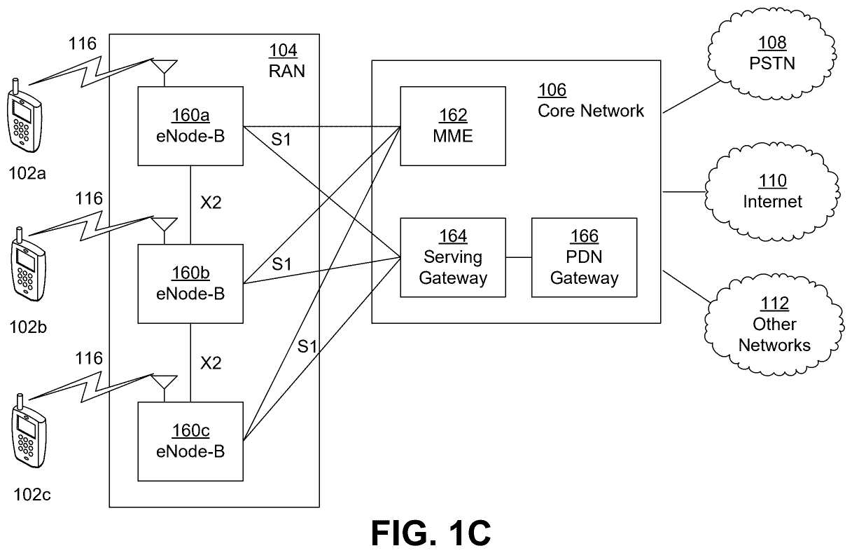

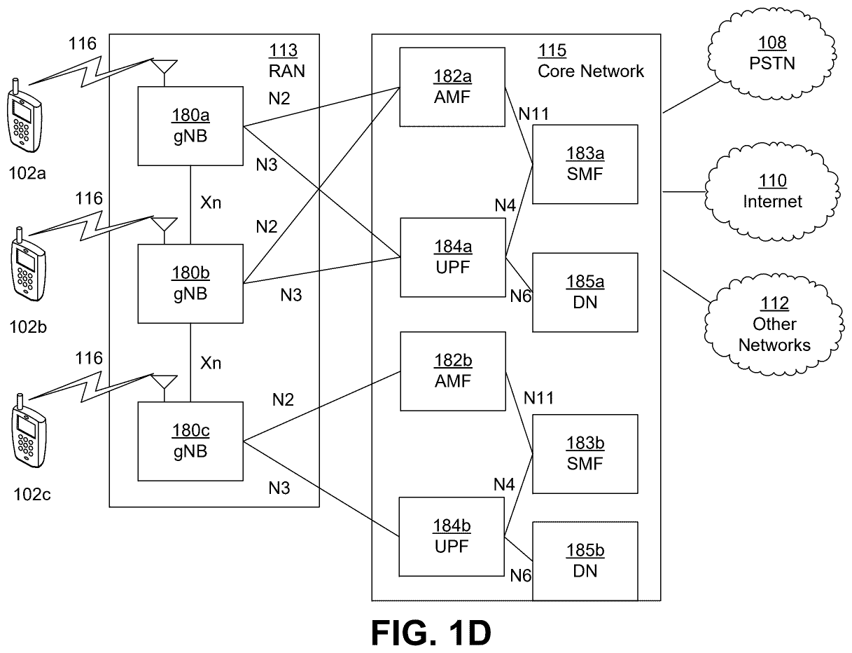

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word DFT-Spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a RAN 104/113, a CN 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a WTRU.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106/115, the Internet 110, and/or the other networks 112. By way of example, the base stations 114a, 114b may be a base transceiver station (BTS), a Node-B, an eNode B, a Home Node B, a Home eNode B, a gNB, a NR NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 115/116/117 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed UL Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., a eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing a NR radio technology, the CN 106/115 may also be in communication with another RAN (not shown) employing a GSM, UMTS, CDMA 2000, WiMAX, E-UTRA, or WiFi radio technology.

The CN 106/115 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/113 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the UL (e.g., for transmission) and downlink (e.g., for reception) may be concurrent and/or simultaneous. The full duplex radio may include an interference management unit 139 to reduce and or substantially eliminate self-interference via either hardware (e.g., a choke) or signal processing via a processor (e.g., a separate processor (not shown) or via processor 118). In an embodiment, the WRTU 102 may include a half-duplex radio for which transmission and reception of some or all of the signals (e.g., associated with particular subframes for either the UL (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (or PGW) 166. While each of the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have an access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., some or all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier Sense Multiple Access with Collision Avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications, such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (CoMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 115 shown in FIG. 1D may include at least one AMF 182a, 182b, at least one UPF 184a,184b, at least one Session Management Function (SMF) 183a, 183b, and possibly a Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different PDU sessions with different requirements), selecting a particular SMF 183a, 183b, management of the registration area, termination of NAS signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for machine type communication (MTC) access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating WTRU IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-ab, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

Systems, methods, and/or apparatus described herein may implement artificial intelligence (AI) and/or machine learning (ML) (AI/ML). For example, one or more devices in the communication system 100 may implement AI/ML. One or more of the WTRUs 102a, 102b, 102c, 102d, the RAN 104/113, and/or the CN 106/115 may implement AI/ML. Additionally, other WTRUs, base stations, and/or network elements may implement AI/ML.

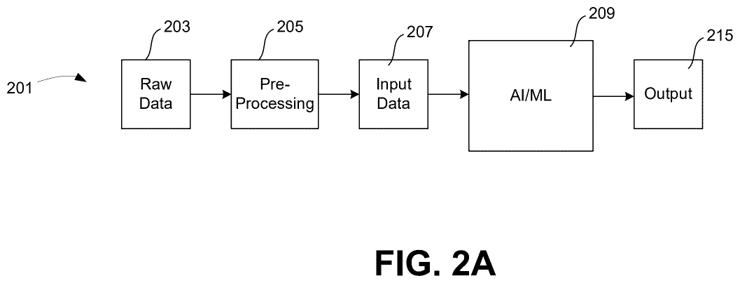

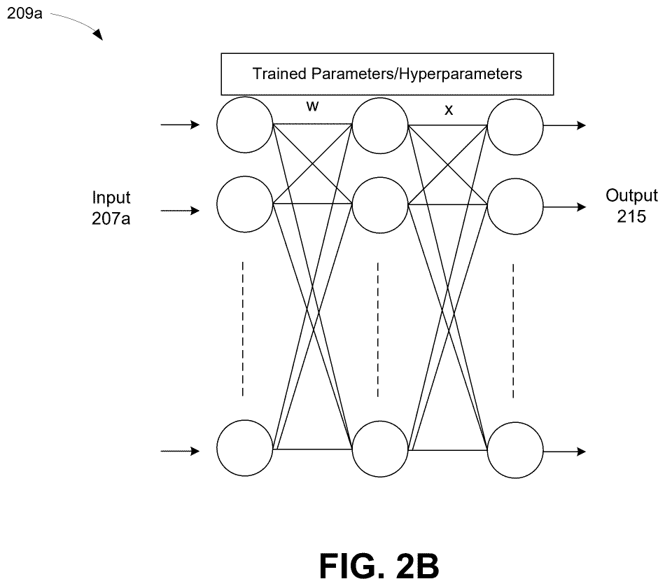

FIG. 2A is a schematic illustration of an example system environment 201 that may implement an AI/ML 209 model. The AI/ML 209 model may include model data and one or more algorithms and/or functions configured to learn from input data 207 that is received to train the AI/ML 209 and/or generate an output 215. The input data 207 may be input in one or more formats, such as an image format, an audio format (e.g., spectrogram or other audio format), a tensor format (e.g., including single-dimensional or multi-dimensional arrays), and/or another data type capable of being input into the AI/ML 209 algorithms. The input data 207 may be the result of pre-processing 205 that may be performed on raw data 203, or the input data 207 may include the raw data 203 itself. The raw data 103 may include image data, text data, audio data, or another sequence of information, such as a sequence of network information related to a communication network, and/or other types of data. The pre-processing 205 may include format changes or other types of processing in order to generate input data 207 in a format for being input into the AI/ML 209 algorithms. For example, image data (e.g., including video data) and/or audio data may be raw data 203 that may be pre-processed during pre-processing 205 to generate the input data 207 in a format configured to be received by the AI/ML 209 algorithm. The output 215 may be generated by the AI/ML 209 algorithm in one or more formats, such as a tensor, a text format (e.g., a word, sentence, or other sequence of text), a numerical format (e.g., a prediction), an audio format, an image format (e.g., including video format), another data sequence format, or/another output format. Output may include one or more analytics and/or prediction, for example as described herein.

AI/ML may be implemented as described herein using software and/or hardware. The AI/ML may be stored as computer-executable instructions on computer-readable media accessible by one or more processors for performing as described herein.

The AI/ML 209 may include one or more algorithms configured for unsupervised learning. Unsupervised learning may be implemented utilizing AI/ML 209 algorithms that learn from the input data 207 without being trained toward a particular target output. For example, during unsupervised learning the AI/ML 209 algorithms may receive unlabeled data as input data 207 and determine patterns or similarities in the input data 207 without additional intervention (e.g., updating parameters and/or hyperparameters). The AI/ML 209 algorithms that are configured for implementing unsupervised learning may include algorithms configured for identifying patterns, groupings, clusters, anomalies, and/or similarities or other associations in the input data 207. For example, the AI/ML may implement hierarchical clustering algorithms, k-means clustering algorithms, k nearest neighbors (K-NN) algorithms, anomaly detection algorithms, principal component analysis algorithms, and/or apriori algorithms. An autoencoder may be a form of AI/ML 209 that may be implemented for unsupervised learning. The autoencoder may include an encoder configured to transform the input data 207 and/or a decoder that may recreate the input data from the data received by the encoder. The autoencoder may be implemented for processing image data and/or other forms of input data. The AI/ML 209 algorithms configured for unsupervised learning may be implemented on a single device or distributed across multiple devices, such that the output 215, or portions thereof, may be aggregated at one or more devices for being further processed and/or implemented in other downstream algorithms or processes, as may be further described herein.

The AI/ML 209 may include one or more algorithms configured for supervised learning. Supervised learning may be implemented utilizing AI/ML 209 algorithms that are trained during a training process to generate a predictive model. Supervised learning may be trained using known outcomes. The AI/ML 209 algorithms may be characterized by parameters and/or hyperparameters that may be trained during the training process. The parameters may include weights, coefficients, and/or biases. The AI/ML 209 may also include hyperparameters. The hyperparameters may include a learning rate, a number of epochs, a batch size, a number of layers, a number of nodes in each layer, a number of kernels (e.g., CNNs), a size of stride (e.g., CNNs), a size of kernels in a pooling layer (e.g., CNNs), and/or other hyperparameters. Some may use certain parameters and hyperparameters interchangeably.

The AI/ML 209 may be trained during supervised learning by receiving training data as input to the AI/ML 209 algorithm and adjusting the parameters and/or hyperparameters based on a known target output 215, while minimizing a loss or error in the output 215 generated by the AI/ML 209 algorithm. During supervised learning, the training data may be labeled prior to being input into the AI/ML 209. The parameters of the AI/ML 209 model may be adjusted using to the model using a loss or error function. The trained AI/ML 209 model may receive the validation data as input to evaluate the model fit on the training data set, while tuning the hyperparameters of the AI/ML 209 model. The AI/ML 209 model may receive the test data to evaluate a final model fit on the training data set and to assess the performance of the AI/ML 209 model. One or more of the training, validation, and/or testing may be performed during supervised learning for different types of AI/ML 209 models.

Supervised learning may be implemented for various types of AI/ML 209 algorithms, including algorithms that implement linear neural networks (NNs), Deep NNs (DNNs), and/or support vector machines (SVMs). NNs and Deep NNs (DNNs) are examples of algorithms utilized in AI/ML models that may be trained using supervised learning. Various examples of NNs include: feed-forward NNs, fully-connected NNs, convolutional Neural Networks (CNNs), recurrent NNs (RNNs), etc.

FIG. 2B illustrates an example of a neural network 209a. The objective of training may be to apply the input 207a as training data and/or adjust one or more weights, indicated as w and x in FIG. 2B (e.g., which may be referred to as neuron weights and/or link weights), such that the output 215 from the neural network 209a approaches the desired target values which are associated with the input 207a values for the training data. In examples, a neural network may include three layers (e.g., as shown in FIG. 2B). During the training, for given input, the difference between output and desired values may be computed and/or the difference may be used to update the one or more weights in the neural network. If a significant (e.g., above a defined threshold) difference between output and desired value(s) is observed, for example, one or more relatively significant (e.g., above a defined threshold) changes in one or more weights may be expected. A difference below a threshold (e.g., between output and desired value(s)) may include one or more relatively small changes (e.g., below the threshold) in one or more weights.

Training a neural network 209a may include identifying one or more of the following information: the input for the neural network; the expected output associated with the input; and/or the actual output from the neural network against which the target values are compared.

In examples, a neural network model may be characterized by one or more parameters and/or hyperparameters, which may include: the number of weights and/or the number of layers in the neural network.

As used herein, the term “deep learning” may refer to a class of machine learning algorithms that employ artificial neural networks (e.g., deep neural networks (DNNs)) which were loosely inspired from biological systems and/or include at least one hidden layer. DNNs may be a special class of machine learning models inspired by the human brain where the input is linearly transformed and/or pass through a non-linear activation function one or more (e.g., multiple) times. DNNs may include one or more (e.g., multiple) layers where one or more (e.g., each) layer includes linear transformation and/or a given non-linear activation function(s). The DNNs may be trained using the training data via a back-propagation algorithm.

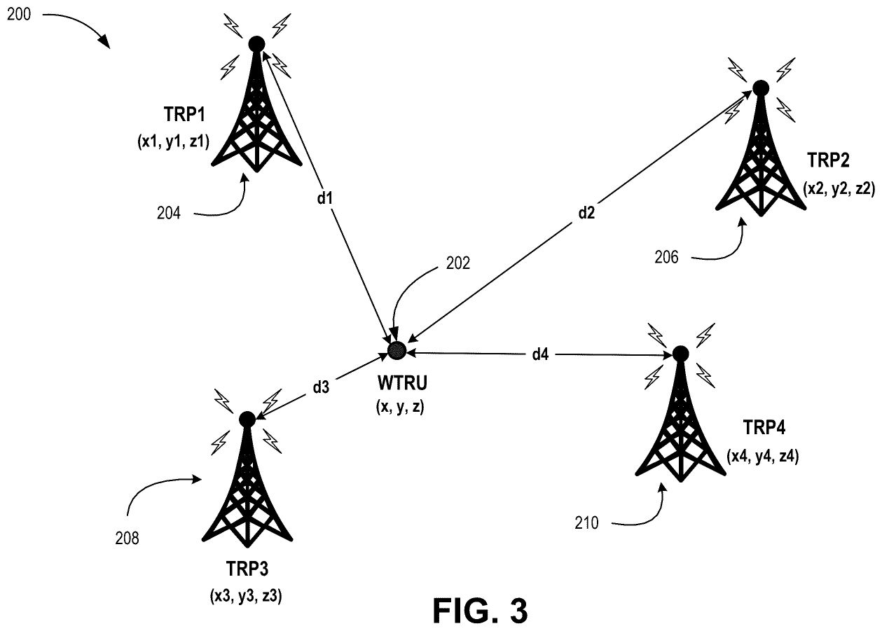

FIG. 3 is a diagram 200 illustrating an example positioning of a wireless transmit/receive unit (WTRU) relative to a plurality of transmit/receive points (TRPs). In this example a WTRU 202 may take measurements from a number of TRPs (e.g., TRP1, TRP2, TRP3, TRP4). The measurements may be performed to determine or predict a position (e.g., x, y, z position) of the WTRU 202. While four (4) TRPs are shown in this exemplary case, any number of TRPs may be utilized to determine or predict the position of the WTRU 202. The coordinates of the TRPs may correspond to a global coordinate system.

The WTRU 202 may operate a fingerprint-based model to predict the position (e.g., x, y, z position) of the WTRU 202. To operate a fingerprint-based model, an end-to-end system may detect a change to a new environment (e.g., using performance monitoring techniques), and then may switch a current model with a model specifically trained for the new environment. This may result in complex workflows for maintaining multiple positioning models for different environments. Having a single universal model which may be implemented in any environment may simplify this workflow. In examples, the embodiments described herein may utilize various methodologies to design and/or train a deep-learning model that, given some measurements (e.g., CIR, TDOA, and/or RSRP) sampled from a variable number of TRPs, can predict the position of a WTRU regardless of the environmental conditions.

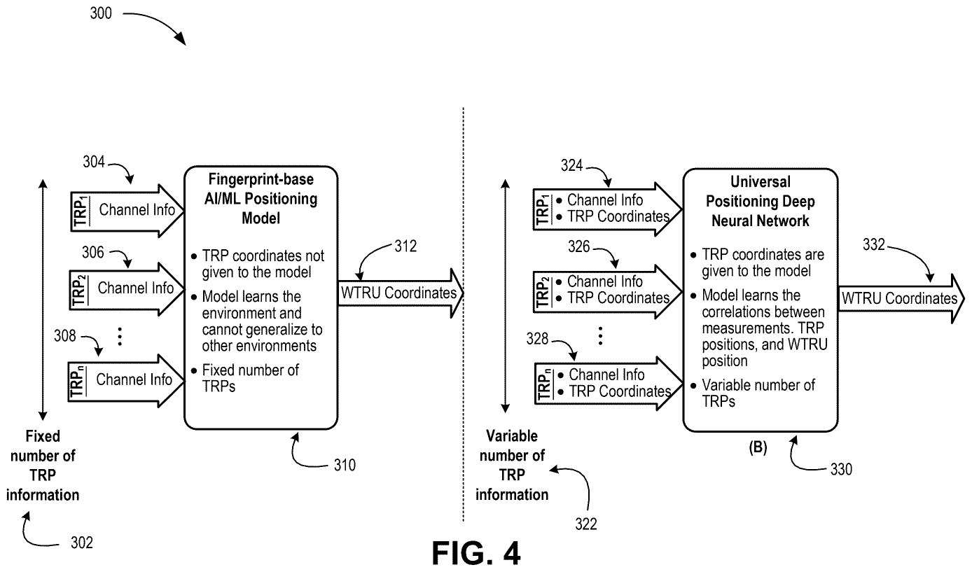

FIG. 4 is a diagram 300 illustrating a comparison between an example fingerprint-based Artificial Intelligence/Machine Learning (AI/ML) positioning model 310 and a deep neural network (DNN) model 330 (e.g., a universal positioning DNN model). Deep-learning models may be designed and trained to predict the position of a user device, such as a Wireless Transmit/Receive Unit (WTRU), by using various measured parameters, including Time Difference of Arrival (TDOA), Channel Impulse Response (CIR), and/or Reference Signal Received Power (RSRP). These parameters capture characteristics of the wireless propagation environment at specific locations, creating unique environmental signatures or “fingerprints.” By sampling different environments, a dataset of fingerprints may be generated to train an AI/ML model to recognize the radio environment characteristics associated with each position. Fingerprint-based models have demonstrated significant improvements over traditional methods in both line-of-sight (LOS) and non-line-of-sight (NLOS) channel conditions. The 3rd Generation Partnership Project (3GPP) has also included AI/ML-based WTRU positioning as a study item.

Most current positioning use cases, including those studied within 3GPP, involve AI/ML models operating within a static environment, learning the “fingerprint” of each location and mapping each fingerprint to specific position coordinates. However, this approach has significant limitations. The trained fingerprint-based model 310 may only function accurately within the original static environment in which it was trained. When a user moves to a different environment, the model's prediction accuracy may degrade significantly. Another challenge with fingerprint-based models is their inability to adapt to dynamic environmental changes, such as the movement of people or vehicles, which alter the position fingerprints and may cause the model to predict incorrect locations.

The fingerprint-based AI/ML positioning model 310 may not receive TRP coordinates as part of its input. Consequently, the model must attempt to learn the environment itself, which restricts its ability to generalize to other environments. This model 310 may also rely on a fixed number of TRPs 302 (e.g., TRP1 304, TRP2 306, and/or TRPn 308) as inputs, which further limits its flexibility. The fixed number of TRPs 302 provides channel information (e.g., CIR, TDOA, and/or RSRP) to the model 310, which then predicts the WTRU coordinates 312 based on these learned environment-specific fingerprints. However, temporary changes in the original environment (e.g., people or objects moving) may significantly degrade the model's performance, resulting in incorrect WTRU coordinates.

To deploy a fingerprint-based model practically, an end-to-end system would first need to detect a change in the environment (e.g., using performance monitoring techniques) and then switch to a model specifically trained for the new environment. This leads to complex workflows requiring multiple positioning models for different environments. A single universal model that operates effectively across any environment could significantly simplify this process.

The DNN model 330 addresses the above limitations by receiving TRP information from a variable number of TRPs 322 (e.g., TRP1 324, TRP2 326, and/or TRPn 328), each of which may provide both channel information and TRP coordinates to the DNN model 330. Unlike the fingerprint-based model, the universal positioning DNN model 330 may receive TRP coordinates, enabling it to learn the correlations between measurements, TRP positions, and WTRU position. The DNN model 330 may build an environment representation from the given information at inference time and may predict the WTRU's position based on this representation, outputting WTRU coordinates 332. The utilization of a variable number of TRPs may include a capability of handling differing numbers of TRPs across setups or scenarios and/or dynamically adapting to changes in the number of active TRPs during operation. For example, the system may be trained and/or tested with static configurations of 5 TRPs in one setup and 9 TRPs in another. Additionally, or alternatively, the number of active TRPs may change dynamically over time, such as transitioning from 5 TRPs at time t₀ to 9 TRPs at time t₁, as influenced by network or environmental conditions.

For illustrative purposes, it may be assumed that the WTRU can measure communication parameters (e.g., CIR, TDOA, and/or RSRP) between itself and any number of TRPs. It may also be assumed that the positions of these TRPs are known to the WTRU. For each TRP, the WTRU may possess the following information: (1) wireless communication parameters such as Channel Matrix, CIR, TDOA, and/or RSRP, and (2) the TRP's position (e.g., coordinates). Both the TRPs and the WTRU may use single or multiple antennas for communication, which may enhance the measurement accuracy and positioning performance. Given a set of TRP information, which may include both wireless communication parameters (e.g., Channel Matrix, CIR, TDOA, and/or RSRP) and TRP positions, the universal positioning DNN model 330 predicts the WTRU coordinates 332 effectively across various environments.

The DNN model 330 may flexibly handle a variable number of TRPs, allowing it to adapt to different environments without the need for environment-specific retraining. Each TRP (e.g., TRP1 324, TRP2 326, and/or TRPn 328) may provide both channel information 324, 326, and/or 328 and TRP coordinates, allowing the model to dynamically adjust to the available TRPs and accurately infer the WTRU coordinates 332. This model learns to build an environment representation by analyzing the correlations between TRP positions, channel information, and WTRU position, rather than relying on fixed environmental fingerprints. By leveraging both channel information and TRP coordinates, the DNN model 330 generalizes effectively, providing robust WTRU positioning in diverse environments without needing multiple models for different settings.

This approach may involve designing and training a deep-learning model that, given TRP communication measurements (e.g., CIR, TDOA, and/or RSRP) and TRP positions, can predict the position of a WTRU regardless of changes in the environment. To train the model, a dataset of TRP channel information, TRP positions, and/or WTRU positions may be created. Further details regarding how to construct the dataset for the supervised training of the model and a deep learning model structure detailed with an example implementation are provided herein below.

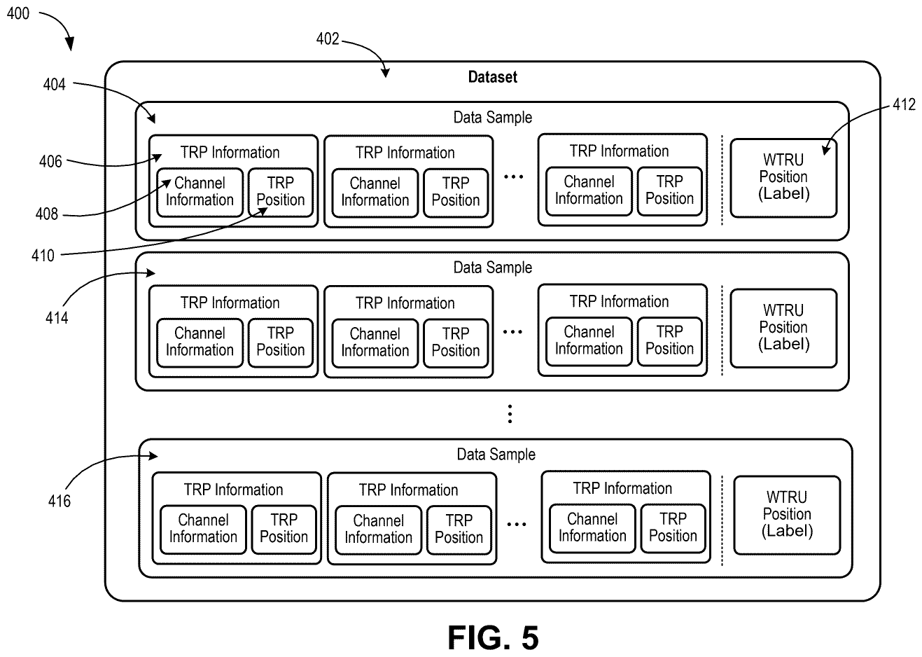

FIG. 5 is a diagram 400 of an example dataset 402 for training a deep-learning model to predict the position of a Wireless Transmit/Receive Unit (WTRU) based on information received from Transmit/Receive Points (TRPs). The dataset 402 may include multiple data samples 404, 414, and/or 416, each of which may contain a sequence of TRP information 406 and a corresponding WTRU position label 412. This dataset structure may enable the model to learn correlations between TRP positions, channel information, and WTRU position, allowing it to build an environment representation and predict the WTRU position in varying environments.

Within each data sample 404, 414, and/or 416, the TRP information sequence 406 may include individual TRP information elements, each of which may include channel information 408 and/or TRP position 410. The channel information 408 may include various communication parameters between the specified TRP and the WTRU, which may include Multiple-Input Multiple-Output (MIMO) channel matrix, Channel Impulse Response (CIR), Time Difference of Arrival (TDOA), and/or Reference Signal Received Power (RSRP). Additionally, the channel information 408 may include a combination of these parameters and/or other relevant channel characteristics. The TRP position 410 may be defined by the x, y, and z coordinates of the specified TRP's location and may be provided within a common Cartesian coordinate system, shared with the WTRU position, ensuring spatial consistency across data samples.

Each TRP information sequence 406 within a data sample 404, 414, and/or 416 may be paired with a WTRU position label 412, which may represent the true position of the WTRU for that particular sample. These WTRU position labels may be used during supervised training to guide the model in learning accurate positioning. Both TRP positions 410 and WTRU position labels 412 may be provided in the same Cartesian coordinate system, ensuring alignment between input data and the output target.

To allow the model to generalize to various conditions, the dataset 402 may include a wide variety of data samples 404, 414, and/or 416, each featuring variations in the number of TRPs, TRP positions, and/or environmental configurations. Different data samples may contain a variable number of TRP information elements 406, with the number of elements in each TRP information sequence ranging from as few as three (the minimum required for basic line-of-sight positioning) to several tens of elements, allowing the model to handle both simple and complex scenarios. Additionally, TRP positions 410 in different data samples may be selected randomly with one or more realistic preconditions, which may prevent the model from attempting to memorize specific TRP layouts. Finally, data samples may represent entirely distinct environments, such as different rooms for indoor settings or various cities for outdoor scenarios, as well as similar environments with varied obstacle layouts, such as different furniture arrangements within the same room.

FIG. 5 illustrates the organization of information in the dataset samples. Each data sample in the dataset 402 contains a set of TRP information 406 associated with the corresponding WTRU position 412, which may be used as ground truth labels during the model training. To prevent the model from learning a single environment during training, the dataset 402 may include data samples with different numbers of TRPs at different locations in various environments. During training, this diversity may help the deep-learning model to infer an environment representation for each individual sample rather than memorizing a single environment.

The dataset 402 may be created, for example, using ray-tracing tools by designing multiple 3-dimensional environments with indoor and/or outdoor configurations, different reflecting materials, and varying densities of obstacles. In each environment, TRPs and WTRUs may be placed at random locations. By running existing ray-tracing programs, the communication channel between the WTRU and each TRP may be simulated at the specified locations to create a diverse set of data samples. The dataset 402 may also include over-the-air captured communication information at different locations and in different environments.

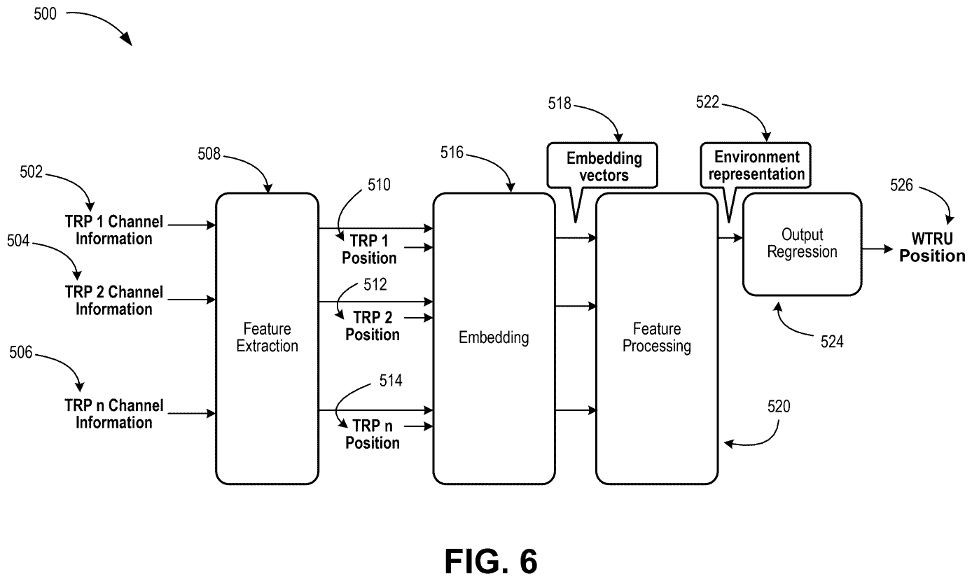

FIG. 6 is a diagram 500 illustrating an example structure for a sequential deep neural network used in a positioning model for Wireless Transmit/Receive Unit (WTRU) positioning. This model structure may combine various state-of-the-art neural network techniques to enable an environment-agnostic positioning solution. The general building blocks of this positioning model are organized into four main components: feature extraction 508, embedding 516, feature processing 520, and output regression 524.

The feature extraction 508 may include receiving as input channel information from multiple TRPs, such as TRP1 channel information 502, TRP2 channel information 504, and TRPn channel information 506. During the training phase, the feature extraction 508 may learn to map the channel information for each TRP into a latent vector, which may then be utilized by the embedding 516 to create TRP embeddings.

The embedding 516 may include combining the latent vectors generated by the feature extraction 508 with positional information for each TRP, such as TRP1 position 510, TRP2 position 512, and TRPn position 514, to form an embedding for each TRP. This process may produce a variable-length sequence of embedding vectors 518, which may then be fed into the feature processing 520, allowing the deep neural network to handle different numbers of TRPs as needed.

The feature processing 520 may include processing the embedding sequence to learn and build a contextual representation of spatial relationships (e.g., environment representation, spatial representation) 522 by combining the TRP information within the sequence. By synthesizing data from multiple TRPs, the feature processing 520 may construct a representation that reflects the spatial layout and signal characteristics of the environment, enabling the model to adapt to varying conditions and configurations.

The output regression 524 may include utilizing the environment representation 522 produced by the feature processing 520 to regress the final WTRU position, i.e., map the environment representation to the Cartesian coordinates of the WTRU position, ultimately outputting the WTRU position 526. The output regression 524 may allow the model to generate precise WTRU location predictions based on the processed TRP data.

This configuration addresses limitations in traditional fingerprint-based positioning methods, which are widely studied in AI/ML-based WTRU positioning systems and included in 3GPP standards. In conventional fingerprint-based approaches, the AI/ML model may learn a unique fingerprint for each position within a specific environment, based on observed channel information between the WTRU and the TRPs. The model may then map these fingerprints to specific WTRU positions. However, such approaches may encounter significant drawbacks, including a lack of generalization to different environments and a decrease in prediction accuracy if environmental conditions change, such as with the addition or movement of furniture, people, or vehicles.

The model structure illustrated in FIG. 6 adopts a different approach by learning the relationships between channel information, TRP positions, and WTRU position. Rather than memorizing static environmental fingerprints, the model may dynamically build an environment representation from the given TRP channel information and TRP positions at inference time and use this representation to predict the WTRU's position. In line-of-sight (LOS) conditions, a WTRU's position may be determined using information from at least three TRPs (e.g., by triangulation). In non-line-of-sight (NLOS) environments, additional TRPs may be utilized to ensure accurate WTRU position estimation.

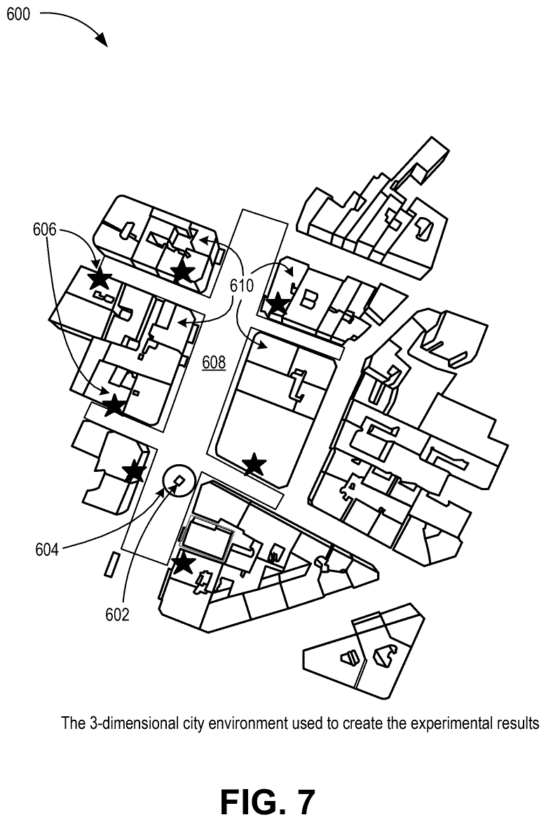

FIG. 7 is a diagram 600 illustrating a 3-dimensional model of a city environment used to generate experimental results for the positioning model. In this simulated environment, Wireless Transmit/Receive Units (WTRUs) 602 and Transmit/Receive Points (TRPs) 606 may be placed at random locations, as shown. The WTRU positions 602 may be selected randomly within a designated area, while the TRP positions 606 (shown as stars) may be selected randomly along both sides of the streets 608, providing diverse placement for signal measurements among the buildings 610.

In this experiment, assuming the actual WTRU position 602, 90% of the predicted WTRU positions may fall within the area 604, indicating a high level of accuracy for the model's predictions under challenging conditions. The dataset for this experiment may be created using a ray-tracing tool to simulate the communication environment. This tool allows for realistic modeling of signal interactions within the 3D city environment, enhancing the robustness of the dataset for testing the positioning model.

It should be noted that while these experiments demonstrate one example of how the proposed solution may be implemented, they may not encompass each aspect of the solution. For instance, in this particular set of experiments, the dataset includes a variable number of TRPs located at random positions, but the data samples are derived from the same environment. This setup provides a foundational view of the model's potential in practical applications.

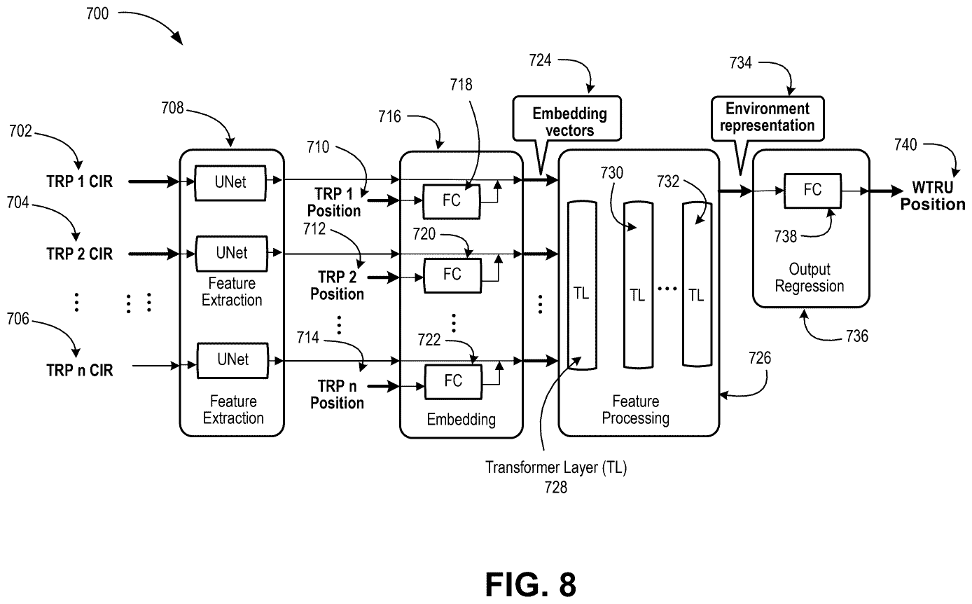

FIG. 8 is a diagram 700 illustrating an example neural network implementation used to generate experimental results for WTRU positioning. In this implementation, the synchronized channel impulse response (CIR) is used as the channel information input. The CIR data for each TRP, including TRP1 CIR 702, TRP2 CIR 704, and TRPn CIR 706, may be input into a feature extraction block 708, which may be implemented based on UNet. The feature extraction block 708 processes the CIR data to produce latent vectors representing the channel information for each TRP.

Within an embedding block 716, the positional information for each TRP, including TRP1 position 712, TRP2 position 714, and TRPn position 710, may be processed through fully connected (FC) layers 718, 720, and/or 722 to generate positional embeddings. These positional embeddings may then be combined with the latent vectors from the feature extraction block 708 to form embedding vectors 724, producing a variable-length sequence of embeddings, one for each TRP.

These embedding vectors 724 may then be input into a feature processing block 726, which may include multiple transformer layers, such as transformer layer 728, transformer layer 730, and transformer layer 732. The feature processing block 726 may process the sequence of embeddings to learn and generate an environment representation 734, capturing spatial relationships and other relevant characteristics of the environment.

In examples, each embedding vector, regardless of number, may pass through each transformer layer sequentially, noting that there may be no one-to-one correspondence between the number of transformer layers and the number of TRP embeddings. Each transformer layer in the feature processing block 726 may be configured to process the entire sequence of embeddings (e.g., each feature embeddings may go through each transformer layers) leveraging mechanisms such as multi-head attention to capture interdependencies and spatial relationships between TRPs.

An output regression block 736 may receive the environment representation 734 as input. Within the output regression block 736, a fully connected (FC) layer 738 may be used to regress the final WTRU position, outputting the WTRU position 740 as the model's prediction. This regression process maps the environment representation to the Cartesian coordinates of the WTRU position, enabling precise location prediction. This implementation demonstrates how the neural network may integrate channel information (CIR data) and positional information for each TRP to generate a spatially aware model that accurately predicts WTRU positions based on environmental context. The feature extraction block 708, embedding block 716, feature processing block 726, and output regression block 736 may execute in sequence to process the input data, generate environment embeddings, and output the predicted WTRU position.

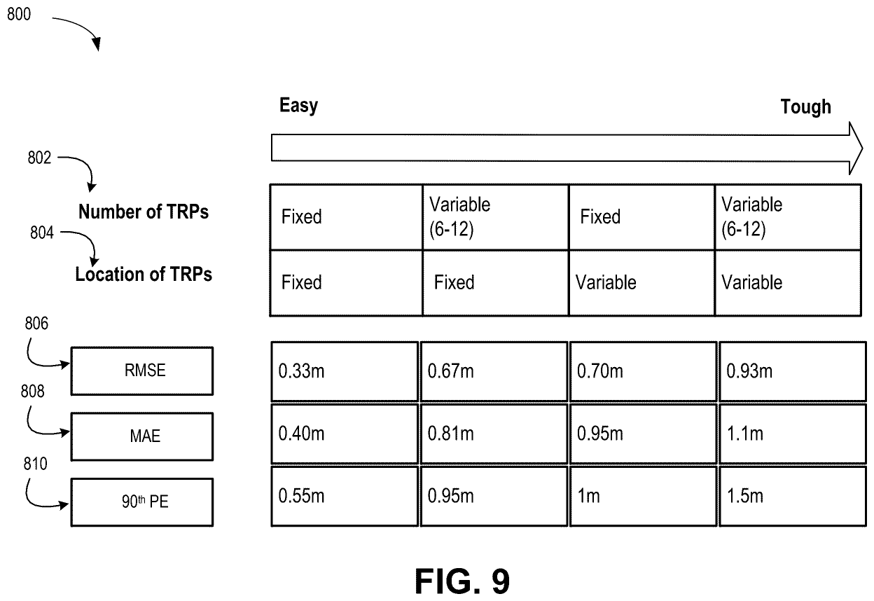

FIG. 9 is a diagram 800 illustrating example performance results of deep-learning models trained in different scenarios with variable and fixed numbers and locations of Transmit/Receive Points (TRPs). The chart provides performance metrics for models across a range of conditions, categorized from “Easy” to “Tough.” These conditions are based on combinations of the number of TRPs 802 and the location of TRPs 804.

The number of TRPs 802 may be either fixed or variable (ranging from 6 to 12), and the location of TRPs 804 may also be fixed or variable. Performance metrics shown in the figure include the Root Mean Square Error (RMSE) 806, Mean Absolute Error (MAE) 808, and 90th Percentile Error (90th PE) 810, measured in meters for each scenario.

For scenarios with a fixed number of TRPs and fixed locations, the model achieved an RMSE 806 of 0.33 meters, an MAE 808 of 0.40 meters, and a 90th PE 810 of 0.55 meters. For scenarios with a variable number of TRPs but fixed locations, the model's RMSE 806 increased to 0.67 meters, with an MAE 808 of 0.81 meters and a 90th PE 810 of 0.95 meters.

In more challenging scenarios, where both the number and location of TRPs were variable, the performance metrics indicate increased errors. For example, with a fixed number of TRPs but variable locations, the model achieved an RMSE 806 of 0.70 meters, an MAE 808 of 0.95 meters, and a 90th PE 810 of 1 meter. In the most challenging scenario, with a variable number of TRPs (6-12) and variable locations, the model recorded an RMSE 806 of 0.93 meters, an MAE 808 of 1.1 meters, and a 90th PE 810 of 1.5 meters.

Additional experiments with more complex configurations, such as increasing the number of TRPs up to 64, incorporating more non-line-of-sight (NLOS) conditions, and using multiple antennas on the WTRU side, yielded a mean absolute error of approximately 11.5 meters and a 90th percentile error of approximately 28 meters.

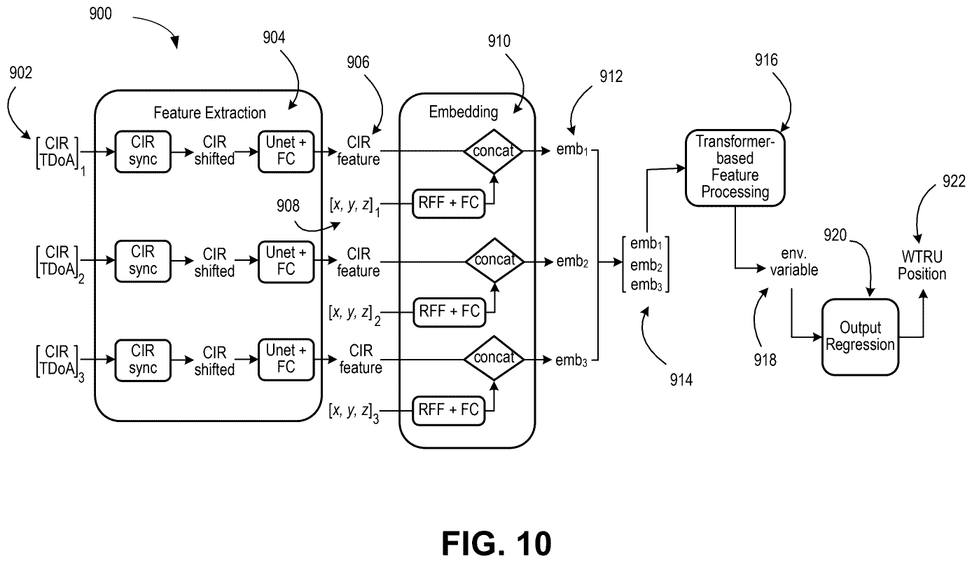

FIG. 10 is a diagram 900 illustrating an example implementation of an environment agnostic position network. A specific example implementation is illustrated for a 3-TRP system with 1 transmit antenna per TRP and 16 receive antennas at the WTRU. However, the generalized version of this framework may be TRP-invariant. Further, although this specific example implementation is presented for ease of illustration, it is to be appreciated that the network may be modified for any other combination of N_tx transmit antennas at each TRP and/or N_rx antennas at the WRTU in various example implementations.

FIG. 10 illustrates various components and processes that may be used to predict a Wireless Transmit/Receive Unit (WTRU) position 914. This architecture may include a pipeline that processes channel impulse response (CIR) and/or time difference of arrival (TDoA) information 902 through feature extraction 904, embedding 910, transformer-based feature processing 916, and/or output regression 920.

At 902, input data may include CIR and/or TDoA information (e.g., [CIR/TDoA]_1, [CIR/TDoA]_2, and [CIR/TDoA]_3) for multiple transmit-receive points (TRPs). Each input may be passed into the feature extraction module 904. At 904, feature extraction may be performed for each TRP input. For instance, [CIR/TDoA]_1, [CIR/TDoA]_2, and [CIR/TDoA]_3 may be processed sequentially. The CIR input for each TRP may first be synchronized (e.g., “CIR sync”) and then shifted (“CIR shifted”) to account for time alignment or offset. These synchronized and shifted CIR inputs may be processed through a UNet model and fully connected (FC) layers, collectively referred to as “UNet+FC,” to generate a CIR feature output.

At 906, the CIR feature output from each TRP may represent a latent vectorized feature encoding the channel information for the respective TRP. This CIR feature may then be paired with corresponding positional information, such as [x, y, z]_1, [x, y, z]_2, and [x, y, z]_3, at 908. These feature and positional pairings may then be passed into the embedding module 910. At 910, embedding vectors may be generated for each TRP. Specifically, CIR features and positional information for each TRP may be independently processed through random Fourier features (RFF) and FC layers (“RFF+FC”). The processed outputs may be concatenated (“concat”) to form embedding vectors, such as emb_1, emb_2, and emb_3, for each TRP.

At 912, the embedding vectors emb_1, emb_2, and emb_3 may be combined into an embedding sequence [emb_1, emb_2, emb_3] at 914. This sequence may then be fed into the transformer-based feature processing module 916. At 916, transformer-based feature processing may use the embedding sequence to create an environment representation (e.g., contextual representation of spatial relationships) labeled “env. variable” at 918. This environment representation may capture spatial correlations between TRPs and the WTRU position.

At 918, the environment representation (e.g., contextual representation of spatial relationships) may be used as input into the output regression module 920. The output regression module 920 may map the environment representation to coordinates in a common Cartesian coordinate system enabling prediction of the WTRU position in Cartesian coordinates (e.g., x, y, z). At 922, the output of the regression module may provide the WTRU position in Cartesian coordinates (e.g., x, y, z). This pipeline may enable the positioning model to generalize across different environments, leveraging a robust and modular design that combines spatial feature extraction, embedding generation, and deep learning-based regression techniques.

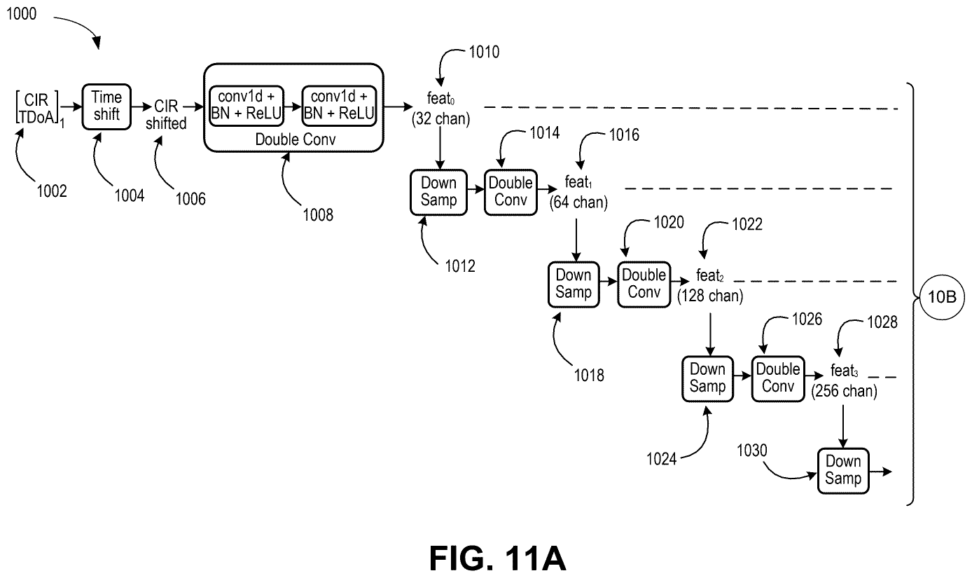

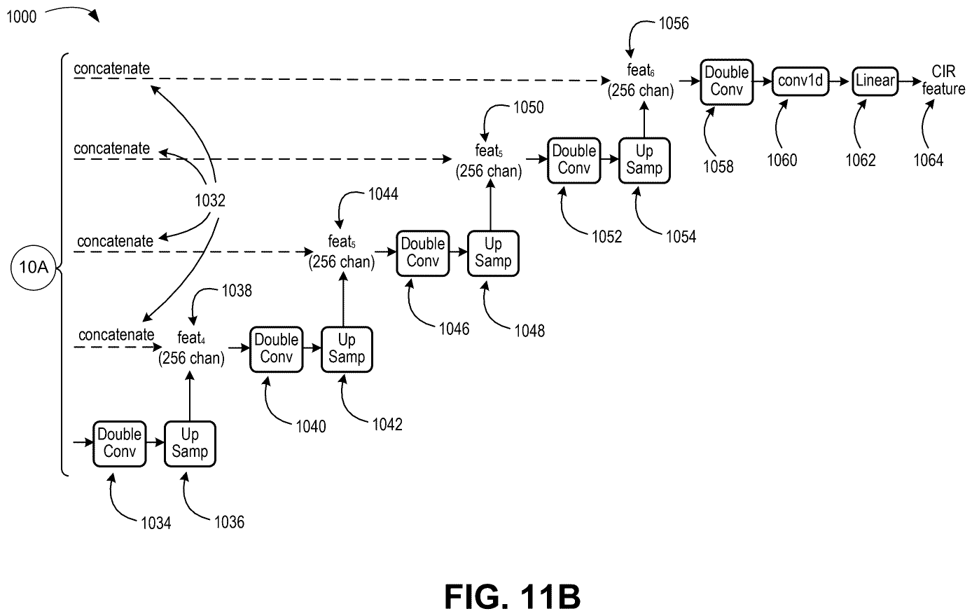

FIGS. 11A and 11B show a diagram 1000 illustrating an example architecture for feature extraction from a channel's channel impulse response (CIR, which may be included as part of an environment-agnostic positioning model. Input data may be received and may include one or more of CIR and/or time difference of arrival (TDOA). The CIR may include complex valued CIR of dimensionality (e.g., Nᵣ*Nₜ*256). This may be presented for a general MIMO setup with Nₜ transmit and Nᵣ receive antennas. The CIR may include 256 taps. For the SISO case, Nᵣ=Nₜ=1 and for the SIMO case Nₜ=1. The process may include processing channel impulse response (CIR) and/or time difference of arrival (TDoA) data through multiple stages of convolutional layers and down-sampling operations, ultimately producing hierarchical feature maps for further processing.

At 1002, the input data may include CIR and/or TDoA information (e.g., [CIR/TDoA]_1). This input data may represent the channel information between a transmit-receive point (TRP) and a Wireless Transmit/Receive Unit (WTRU). At 1004, a time-shifting operation may be applied to the input CIR/TDoA information to align and normalize the data. The result of this operation may be referred to as “CIR shifted.”

At 1006, the time-shifted CIR may be passed into an initial double convolutional block 1008. This block may include two 1D convolutional layers, each followed by batch normalization (BN) and a Rectified Linear Unit (ReLU) activation function. These operations may extract initial features from the shifted CIR data. At 1010, the output of the double convolutional block may be referred to as feat_0 (32 channels). This feature map may then be processed through additional layers for further feature extraction and down-sampling.

At 1012, a down-sampling operation (Down Samp) may reduce the spatial resolution of feat_0 while increasing its representational capacity. This operation may help capture higher-level abstractions of the input data. At 1014, the down-sampled feature map may be passed into another double convolutional block, producing a refined feature map referred to as feat_1 (64 channels) 1016. This feature map may capture comparatively more complex spatial patterns and relationships. At 1018, a second down-sampling operation may be applied to feat_1, further reducing its spatial resolution and preparing it for deeper feature extraction layers. At 1020, the down-sampled feature map may be processed through another double convolutional block, producing feat_2 (128 channels) 1022. This step may encode more abstract representations of the input data.

At 1024, another down-sampling operation may be applied to feat_2, further reducing its size while retaining critical spatial information. At 1026, the resulting feature map may be passed through yet another double convolutional block, generating feat_3 (256 channels) 1028. This feature map may represent the highest level of abstraction in the feature extraction process. At 1030, a final down-sampling operation may prepare the output feature map for input into the subsequent processing module. This output may be passed to the next stage of the pipeline, as described further herein below with reference to FIG. 11B. This architecture may enable the model to capture hierarchical representations of CIR and/or TDoA data, leveraging progressively deeper layers to extract meaningful features while reducing the spatial dimensionality of the input data.

FIG. 11B is a diagram 1000 illustrating an example architecture for hierarchical feature reconstruction as part of an environment-agnostic positioning model. The figure depicts the process of reconstructing features from low-dimensional embeddings through up-sampling and concatenation operations, ultimately generating CIR features for use in subsequent modules.

At 1034, the process may begin with feat_3 (256 channels) generated in FIG. 11A. This feature map may undergo a double convolution operation, followed by an up-sampling operation at 1036. The up-sampled feature map may be concatenated with the corresponding feature map from a previous layer, as indicated at 1032. At 1038, the concatenated feature map may be processed through another double convolution block 1040. The output of this block may undergo an up-sampling operation at 1042, followed by another concatenation with a feature map from a previous layer, as shown at 1032.

At 1044, the up-sampled and concatenated feature map may pass through another double convolution block 1046. This output may then undergo an up-sampling operation at 1048, followed by further concatenation at 1032 with another feature map from an earlier layer. At 1050, the hierarchical feature map reconstruction process may continue with another double convolution block 1052, producing an up-sampled feature map at 1054. This feature map may be referred to as feat_6 (256 channels) at 1056, which represents the final high-resolution feature map in this reconstruction process.

At 1058, feat_6 may pass through an additional double convolution block, further refining the reconstructed features. The refined feature map may then be processed through a 1D convolutional layer at 1060, followed by a linear transformation at 1062. At 1064, the output of the linear layer may be referred to as the “CIR feature.” This CIR feature may serve as input to subsequent modules, such as embedding or regression modules, for environment-agnostic positioning. This hierarchical feature reconstruction process may leverage up-sampling and concatenation to retain spatial information from earlier feature maps while progressively refining the resolution and quality of the reconstructed features.

In examples, one or more DNN parameters may be indicated, and may include, for example, time shift, double convolution (Double Conv), down sample, up sample, output convolution, and or linear parameters. The time shift may be an algorithmic operation that pads the CIR, appropriately, based on the TDOA value. The double convolution may include, for example, a first convolution (first conv1d) and/or second convolution (second conv1d). The first conv1d may be a 1d convolution taking in C_in input channels and outputting C_out output channels with a kernel of size 3 and zero padding to maintain the input data dimensionality. The second conv1d may be a 1d convolution taking in C_out input channels and outputting C_out output channels with a kernel of size 3 and zero padding to maintain the input data dimensionality. The value of C_in and C_out may depend on the U-Net stage, as shown in FIG. 11. The intermediate skip connections in the U-Net may concatenate the data along the channel dimension to effectively double the input channels to the subsequent Double Conv block. The final Double Conv block may outputs 16 channels.

The down sample may be the maxpool operation that reduces the input dimensionality by, for example, 2. The up sample may include increasing the input dimensionality by a factor of 2 using, for example, bilinear interpolation. The output convolution (conv1d) may be a 1d convolution with a kernel of, for example, size 1 and 6 output channels. The linear parameter may indicate a linear layer and/or fully connected DNN layer with, for example, an input dimension of 1536 and an output dimension of 128.

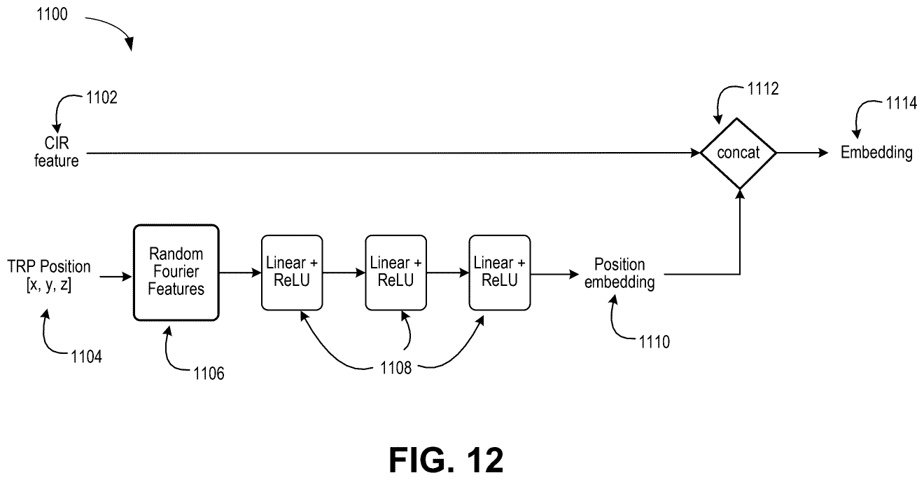

FIG. 12 is a diagram 1100 illustrating an example embedding block and an example process for generating an embedding vector by combining CIR features and TRP positional information. This embedding vector may encapsulate both spatial and feature-based information, enabling its use in positioning tasks. DNN parameters may include, for example, random Fourier features (RFF). The RFF may be evaluated with parameters sigma=10.0 and output dimension 64 for each of the sine and cosine feature. The resulting output of the RFF block may be a vector of dimension 128. A linear layer may be utilized, and may be a fully connected DNN layer with input size 128 and output size 128 for each of the layers. The position embedding may be concatenated to the CIR embedding to create the final embedding of dimension 256.

At 1102, the process may begin with input CIR features, which may represent processed channel impulse response data corresponding to a specific TRP. These CIR features may be passed directly to a concatenation operation at 1112 for combination with positional embeddings. At 1104, the three-dimensional Cartesian coordinates of the TRP, represented as TRP position [x, y, z], may serve as an input to the embedding generation process. These positional coordinates may be used to derive spatial information about the TRP. At 1106, the TRP position data may be processed through a Random Fourier Features block, which may transform the positional data into a higher-dimensional space to capture periodic relationships and spatial patterns inherent in the TRP position.

At 1108, the output of the Random Fourier Features block may pass through a series of three Linear+ReLU layers. These layers may include fully connected (FC) operations followed by rectified linear unit (ReLU) activations, refining the transformed positional data into meaningful feature representations. At 1110, the output of the Linear+ReLU layers may result in a position embedding. This embedding may encapsulate the spatial information of the TRP, structured for combination with the CIR features. At 1112, the concat block may combine the CIR features from 1102 with the position embedding from 1110. This concatenation may produce a unified representation that integrates both the feature-based and spatial data for the TRP.

At 1114, the output of the concatenation block may be an embedding vector that combines the CIR feature and positional information. This embedding vector may be used in subsequent stages of the positioning model to generalize across environments and improve positioning accuracy. This embedding generation process may ensure that both spatial and channel characteristics of the TRP are captured in a robust and unified representation, enabling the positioning model to better interpret the relationship between TRPs and the WTRU position.

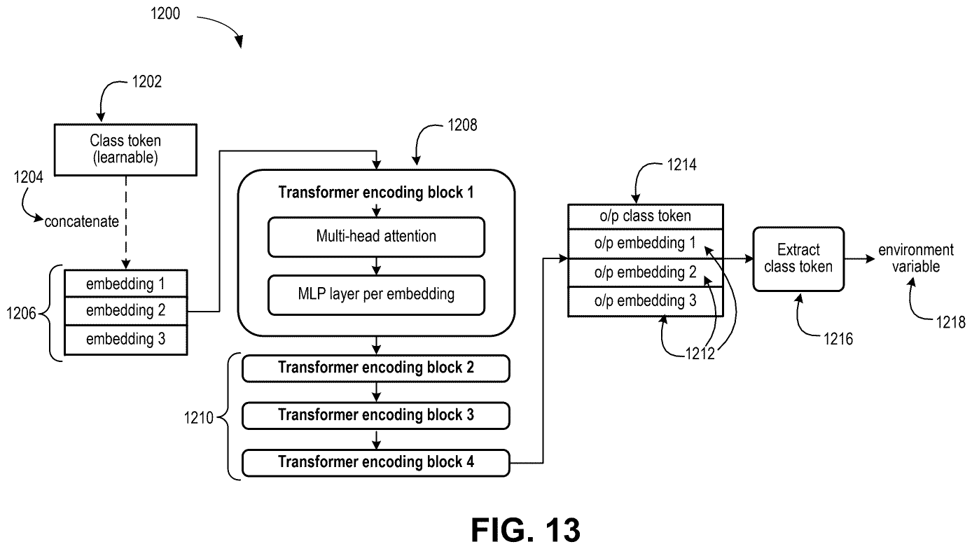

FIG. 13 is a diagram 1200 illustrating an example transformer-based feature processing architecture for deriving an environment representation (e.g. spatial representation) or variable 1218 from embedding vectors utilizing generated embeddings. The process may involve several stages, including the incorporation of a learnable class token, multi-layered transformer encoding, and class token extraction. Embeddings may be input, and may include, for example, three embeddings (1, 2, and 3), which may each be evaluated for the three TRPs described above with reference to the 3-TRP system illustrated in FIG. 10. A class token may be a dummy embedding added at the top of the TRP embeddings, giving a total number of Nₜᵣₚ+1 input sequences to the feature processing block. The initial value of the class token may be learned during DNN training. The use of the class token may be particularly useful to make an entire network invariant to the total number of TRPs.

At 1202, a class token (learnable) may be introduced. This token may serve as an additional input to the transformer-based processing, representing a shared feature across each of the embeddings. At 1204, the class token may be concatenated with embedding vectors 1206 (e.g., embedding 1, embedding 2, and embedding 3). These embedding vectors may originate from earlier stages of the positioning pipeline, such as the embedding module depicted in FIG. 12. The concatenated inputs may then be provided to the first transformer encoding block. At 1208, the concatenated inputs, including the class token and the embedding vectors, may be processed by Transformer Encoding Block 1. This block may include operations such as multi-head attention, which may capture relationships between different embedding vectors and the class token, as well as a MLP (multi-layer perceptron) layer per embedding, which may refine the individual embeddings.

At 1210, the outputs of Transformer Encoding Block 1 may propagate through additional transformer encoding blocks (e.g., Transformer Encoding Block 2, Transformer Encoding Block 3, and Transformer Encoding Block 4). Each block may apply multi-head attention and MLP layers to iteratively refine the embedding representations and the class token. At 1212, the output from the final transformer encoding block may include a set of embeddings (e.g., o/p embedding 1, o/p embedding 2, and o/p embedding 3) and the o/p class token. These outputs may capture refined spatial and feature representations derived from the input embeddings.

At 1214, the outputs may be collected for further processing. The o/p class token may be extracted separately at 1216, providing a summarized representation of the processed embeddings. This extracted class token may then be used to derive the environment variable at 1218, which may encode spatial and feature-based correlations between the transmit-receive points (TRPs) and the Wireless Transmit/Receive Unit (WTRU) position. This transformer-based processing architecture may enable the model to dynamically aggregate and interpret relationships between multiple TRPs and the WTRU, resulting in a robust environment representation that can adapt to diverse scenarios.

DNN parameters may include four sequential transformer encoder blocks that may extract information from the different TRP embeddings. Each transformer encoder block may consist of a multi-head attention block with four attention heads and a dropout rate of 0.1 per encoder. The MLP layer may consist of three fully connected layer with an input dimension of 256, a hidden state dimension of 1024, and an output dimension of 256. The hidden state dimension may include a rectified linear unit (RELU) nonlinearity. The MLP layer may act separately on each output embedding of the multi-head attention block of each transformer encoder. The class token may be extracted at the end, which may give the final environment variable of dimension 256. This dimension of the environment variable may be independent of the number of TRPs used.

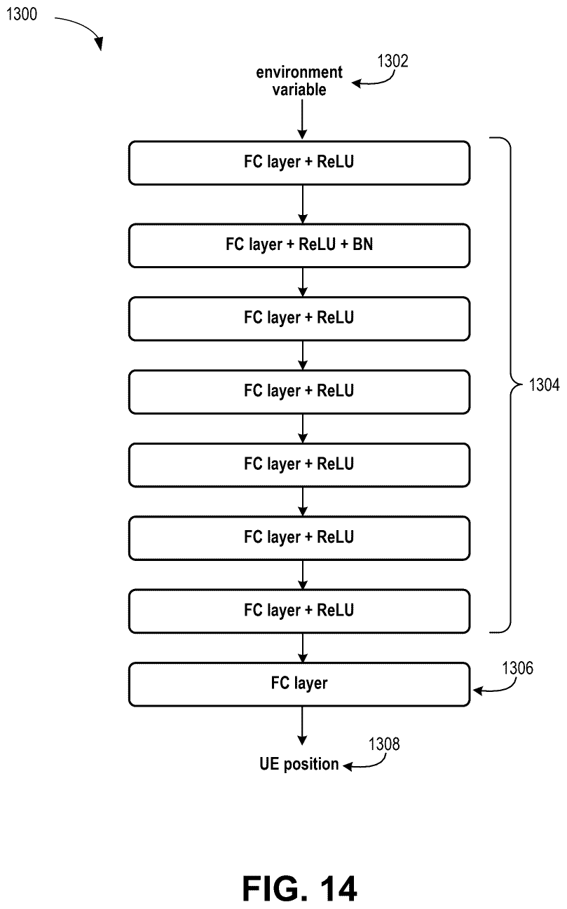

FIG. 14 is a diagram 1300 illustrating an example architecture for output regression module for predicting a position of a WTRU. The module may process the environment variable 1302, derived from components such as the transformer-based feature processing module in FIG. 13, to generate a positional output 1308. The DNN parameters may include a sequence of fully connected (FC) layers. FC layer 1 may have an input dimension of size 256 and an output dimension of size 128. FC layer 2 through 7 may have an input dimension of size 128 and an output dimension of size 128. FC layer 8 may have an input dimension of size 128 and an output dimension of size 3.

At 1302, the environment variable may serve as the input to the output regression module. This environment variable may encapsulate spatial and feature correlations between transmit-receive points (TRPs) and the WTRU. At 1304, a sequence of fully connected (FC) layers may process the environment variable. Each FC layer may include a rectified linear unit (ReLU) activation function to introduce non-linearity into the processing pipeline. Some layers may additionally incorporate batch normalization (BN) to stabilize and enhance the training process. The stacked FC layers may iteratively refine the input environment variable into a higher-level representation. At 1306, a final FC layer without a ReLU activation may be applied. This layer may map the refined representation to Cartesian coordinates representing the WTRU's position.

At 1308, the positional output of the regression module may represent the WTRU position in three-dimensional space (e.g., x, y, z coordinates). This position may be computed based on the environment representation and learned spatial correlations captured by the overall positioning model. This regression module architecture may enable accurate position prediction by progressively transforming the environment representation into a concrete spatial coordinate output. The deep stack of FC layers may enhance the model's ability to generalize across diverse and complex environments.

The spatial coordinates of the TRPs may be expressed relative to an absolute reference frame, such as GPS coordinates provided by a GPS chipset, and/or a local reference frame, such as those used in indoor positioning systems. Absolute spatial coordinates may be determined by external positioning sources, such as GPS chipsets, while relative spatial coordinates may be derived from specific deployment environments, such as, for example, an anchor point in a warehouse or factory setup.

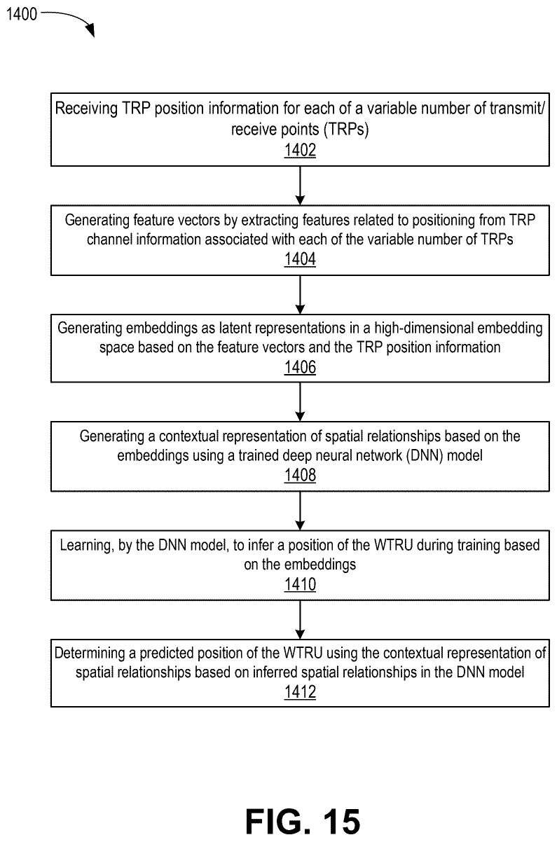

FIG. 15 is a diagram 1400 illustrating an example method for determining WTRU positioning using an environment-agnostic deep-learning model. At 1402, TRP position information may be received for each of a variable number of transmit/receive points (TRPs). The TRP position information may include spatial coordinates for each of the variable number of TRPs. At 1404, feature vectors may be generated by extracting features related to positioning from TRP channel information associated with each of the variable number of TRPs. The TRP channel information may include signal and spatial information. The extracting features may be based on the signal and spatial information associated with each of the variable number of TRPs.

At 1406, embeddings may be generated as latent representations in a high-dimensional embedding space based on the feature vectors and the TRP position information. At 1408, a contextual representation of spatial relationships may be generated based on the embeddings using a trained deep neural network (DNN) model. The DNN model may be trained on training data comprising varying numbers and geometric configurations of TRPs to enable generalization across different environments. At 1410, the DNN model may learn to infer a position of the WTRU during training based on the embeddings. At 1412, a predicted position of the WTRU may be determined using the contextual representation of spatial relationships based on inferred spatial relationships in the DNN model.

Generalization across different environments refers to an ability to accurately predict WTRU positions across diverse conditions without requiring retraining of the model. These conditions may include varying numbers of TRPs, geometric configurations of TRPs, propagation characteristics such as line-of-sight and non-line-of-sight, and/or deployment environments such as urban, rural, or indoor scenarios. This generalization may be achieved by training the model using datasets from multiple environments, including for example, varying numbers of TRPs at different spatial configurations and environments. The datasets may be constructed to include both indoor and outdoor settings, with diverse obstacle layouts and/or channel conditions. Thus, the model may learn patterns in the data that are not tied to specific environment configurations, enabling accurate performance (e.g., WTRU positioning prediction) in unseen deployment scenarios and/or environmental conditions.

In examples, at 1402, the WTRU may receive Transmit/Receive Point (TRP) position information for each of a variable number of TRPs. The TRP position information may include spatial coordinates (e.g., [x, y, z]) for each TRP, enabling the system to account for the spatial distribution of TRPs. Additionally, associated TRP channel information may include at least one of a channel matrix, channel impulse response (CIR), time difference of arrival (TDoA), or reference signal received power (RSRP).

At 1404, the WTRU may generate feature vectors by extracting features related to positioning from the TRP channel information. This step may involve processing the signal and spatial information associated with each TRP to produce feature vectors that encode relevant positioning data. The feature extraction may be based on channel characteristics, and the feature vectors may be informed by relationships between TRP channel information and position information.

At 1406, embeddings may be generated as latent representations in a high-dimensional embedding space. The embeddings may be produced by combining the feature vectors with the TRP position information of corresponding TRPs. These embeddings may serve as intermediate representations that capture relationships between TRPs and the WTRU in a manner that is robust to changes in the number or configuration of TRPs.

At 1408, the WTRU may generate a contextual representation of spatial relationships using a trained DNN model. The embeddings may be processed through the DNN to produce this representation, which may encode inferred relationships between the TRPs and the WTRU. The DNN model may be trained on data with varying numbers and geometric configurations of TRPs to enable generalization across different environments. This training may allow the DNN to infer the WTRU position without retraining, regardless of changes in the number or arrangement of TRPs.

At 1410, the DNN model may learn to infer the position of the WTRU during training based on the embeddings. This learning process may utilize relationships encoded in the contextual representation to predict WTRU positions accurately. At 1412, the WTRU may determine a predicted position using the contextual representation of spatial relationships produced by the DNN. This process may involve mapping the contextual representation to coordinates within a common Cartesian coordinate system using an output regression component.

The contextual representation of spatial relationships may comprise encoded positioning data that reflects learned relationships between TRP position and channel information. Additionally, the DNN model may include a class token added to the embeddings. This class token may provide an input sequence that makes the DNN invariant to the number of TRPs and may be learned during training. The embeddings and class token may be processed by a transformer-based feature processing block, which may compute the contextual representation while maintaining invariance to TRP count and configuration. This method may leverage modular components, environment-agnostic training, and deep learning techniques to achieve robust WTRU positioning across dynamic and diverse environments.

1. A wireless transmit/receive unit (WTRU) comprising:
a processor configured to:
receive TRP position information for each of a variable number of transmit/receive points (TRPs), wherein the TRP position information comprises spatial coordinates for each of the variable number of TRPs;
generate feature vectors by extracting features related to positioning from TRP channel information associated with each of the variable number of TRPs, wherein the TRP channel information comprises signal and spatial information;
generate embeddings as latent representations in a high-dimensional embedding space based on the generated feature vectors and the received TRP position information;
generate a contextual representation of spatial relationships based on the generated embeddings using a trained deep neural network (DNN) model, wherein the DNN model is trained on training data comprising varying numbers and geometric configurations of TRPs to enable generalization across different environments, and wherein the DNN model learns to infer a position of the WTRU during training based on the embeddings; and
determine a predicted position of the WTRU using the generated contextual representation of spatial relationships based on inferred spatial relationships in the DNN model.

2. The WTRU of claim 1, wherein the TRP channel information comprises at least one of a channel matrix, channel impulse response (CIR), time difference of arrival (TDOA), or reference signal received power (RSRP) associated with the TRPs.

3. The WTRU of claim 1, wherein the embeddings are generated by combining the feature vectors with the TRP position information of corresponding TRPs.

4. The WTRU of claim 1, wherein the contextual representation of spatial relationships comprises inferred relationships between the variable number of TRPs and the WTRU based on the embeddings.

5. The WTRU of claim 1, wherein the DNN model is agnostic to different numbers of TRPs and geometric configurations, and
wherein the predicted position of the WTRU is determined using the contextual representation of spatial relationships based on inferred spatial relationships in the DNN model without retraining the DNN model.

6. The WTRU of claim 1, wherein the DNN model comprises an output regression component configured to determine the predicted position of the WTRU by mapping the contextual representation of spatial relationship to coordinates within a common Cartesian coordinate system.

7. The WTRU of claim 1, wherein the DNN model is configured to generate the contextual representation of spatial relationships and to determine the predicted position of the WTRU in both line-of-sight (LOS) and non-line-of-sight (NLOS) conditions.

8. The WTRU of claim 1, wherein the contextual representation of spatial relationships comprises encoded positioning data based on learned relationships between the TRP position information and the TRP channel information.

9. The WTRU of claim 1, wherein the DNN model comprises a class token added to the embeddings, wherein the class token provides an input sequence that makes the network invariant to a total number of TRPs.

10. The WTRU of claim 9, wherein the DNN model comprises a transformer-based feature processing block configured to receive the embeddings and the class token, wherein the class token has an initial value learned during DNN training.

11. A method implemented by a wireless transmit/receive unit (WTRU), the method comprising:
receiving TRP position information for each of a variable number of transmit/receive points (TRPs), wherein the TRP position information comprises spatial coordinates for each of the variable number of TRPs;
generating feature vectors by extracting features related to positioning from TRP channel information associated with each of the variable number of TRPs, wherein the TRP channel information comprises signal and spatial information;
generating embeddings as latent representations in a high-dimensional embedding space based on the generated feature vectors and the received TRP position information;
generating a contextual representation of spatial relationships based on the generated embeddings using a trained deep neural network (DNN) model, wherein the DNN model is trained on training data comprising varying numbers and geometric configurations of TRPs to enable generalization across different environments, and wherein the DNN model learns to infer a position of the WTRU during training based on the embeddings; and
determining a predicted position of the WTRU using the generated contextual representation of spatial relationships based on inferred spatial relationships in the DNN model.

12. The method of claim 11, wherein the TRP channel information comprises at least one of a channel matrix, channel impulse response (CIR), time difference of arrival (TDOA), or reference signal received power (RSRP) associated with the TRPs.

13. The method of claim 11, wherein the embeddings are generated by combining the feature vectors with the TRP position information of corresponding TRPs.

14. The method of claim 11, wherein the contextual representation of spatial relationships comprises inferred relationships between the variable number of TRPs and the WTRU based on the embeddings.

15. The method of claim 11, wherein the DNN model is agnostic to different numbers of TRPs and geometric configurations, and
wherein the predicted position of the WTRU is determined using the contextual representation of spatial relationships based on inferred spatial relationships in the DNN model without retraining the DNN model.

16. The method of claim 11, wherein the DNN model comprises an output regression component configured to determine the predicted position of the WTRU by mapping the contextual representation of spatial relationship to coordinates within a common Cartesian coordinate system.

17. The method of claim 11, wherein the DNN model comprises an output regression component configured to determine the predicted position of the WTRU by mapping the contextual representation of spatial relationship to coordinates within a common Cartesian coordinate system.

18. The method of claim 11, wherein the contextual representation of spatial relationships comprises encoded positioning data based on learned relationships between the TRP position information and the TRP channel information.

19. The method of claim 11, wherein the DNN model comprises a class token added to the embeddings, wherein the class token provides an input sequence that makes the network invariant to a total number of TRPs.

20. The method of claim 19, wherein the DNN model comprises a transformer-based feature processing block configured to receive the embeddings and the class token, wherein the class token has an initial value learned during DNN training.
